(19) United States
(12) Patent Application Publication
(10) Pub. No.: US 2008/0147851 A1
(43) Pub. Date: Jun. 19, 2008

(54) SYSTEM AND METHOD FOR MONITORING WEB PAGE ALTERATIONS

(75) Inventors: Chung-I Le, Tu-Cheng (TW); Chien-Fa Yeh, Tu-Cheng (TW); Xiang Yang, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/847,354

(22) Filed: Aug. 30, 2007

(30) Foreign Application Priority Data
Dec. 15, 2006 (CN) 200610157548.2

(51) Int. Cl. G06F 15/173

(52) U.S. Cl. 709/224

(57) ABSTRACT

A method for monitoring Web page alterations is provided. The method includes the steps of setting system working time; determining whether current time is within the system working time; reading an XQuery document from an application server if the current time is within the system working time; obtaining a Uniform Resource Locator in the XQuery document and linking to the Uniform Resource Locator; determining whether a Web page corresponding to the Uniform Resource Locator can be accessed; analyzing contents of the Web page to identify target contents by invoking the XQuery document if the Web page corresponding to the Uniform Resource Locator can be accessed; and monitoring whether the target contents of the Web page have been changed.

### BACKGROUND OF THE INVENTION

1. Field of the Invention

The present invention relates to systems and methods for monitoring Web pages particularly to a system and method for monitoring Web page alterations.

2. Description of Related Art

By the advent of the Internet, enormous amounts of information have become easily accessible. The Internet gives user access to more than 2.7 billion Websites, and the rate of growth has been shown to be about 80 new Website per second. Thus, users of the Internet may access more than 550 billion documents. Furthermore, a lot of the information available through the Internet is variable or floating information that may change over time, and users need to access those sites frequently to check if their information of interest has been changed or updated. Statistics have shown that 43% of the Internet users access about 20 Websites each month to look for such updates. Accordingly, there is a need for a solution that will assist a user in finding out whether information on the Web site of interest has been changed or updated.

What is needed, therefore, is a system for monitoring Web page alterations, which can be used for monitoring whether the Web pages have been changed.

Similarly, what is also needed is a method for monitoring Web page alterations, i.e., for monitoring whether the Web pages have been changed.

### SUMMARY OF THE INVENTION

A system for monitoring Web page alterations is disclosed. The system includes an application server, a database coupled to the application server, and a Web server electronically connected with the application server via a network. The application server includes: a setting module for setting system working time; a determining module for determining whether current time is within the system working time; a reading module for reading an XQuery document from the application server if the current time is within the system working time; a linking module for obtaining a Uniform Resource Locator in the XQuery document and linking to the Uniform Resource Locator; and an analyzing module for analyzing contents of a Web page corresponding to the Uniform Resource Locator to identify target contents by invoking the XQuery document if the Web page corresponding to the Uniform Resource Locator can be accessed, wherein the determining module is for monitoring whether the target contents of the Web page have been changed.

Another preferred embodiment provides a method for monitoring Web page alterations. The method includes the steps of setting system working time; determining whether current time is within the system working time; reading an XQuery document from an application server if the current time is within the system working time; obtaining a Uniform Resource Locator in the XQuery document and linking to the Uniform Resource Locator; determining whether a Web page corresponding to the Uniform Resource Locator can be accessed; analyzing contents of the Web page to identify target contents by invoking the XQuery document if the Web page corresponding to the Uniform Resource Locator can be accessed; and monitoring whether the target contents of the Web page have been changed.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of hardware configuration of a system for monitoring Web page alterations in accordance with a preferred embodiment;

FIG. 2 is a schematic diagram of main function unit of an application server of FIG. 1; and

FIG. 3 is a flowchart of a preferred method for monitoring Web page alterations in accordance with a preferred embodiment.

### DETAILED DESCRIPTION OF THE INVENTION

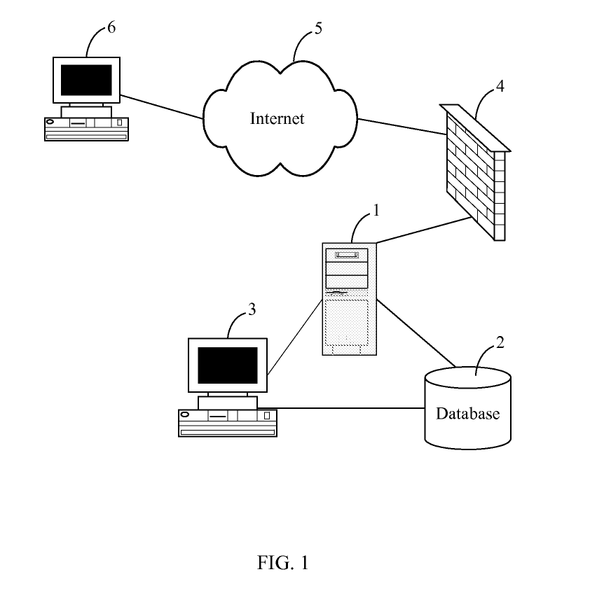

FIG. 1 is a schematic diagram of hardware configuration of a system for monitoring Web page alterations (hereinafter, “the system”) in accordance with a preferred embodiment of the present invention. The system typically includes an application server 1, a database 2, a client 3, and a Web server 6. The application server 1 is used for browsing Web pages via the Web server 6 from the Internet 5, and comparing current information of the Web pages and corresponding historical information of the Web pages stored in the database 2 to detect whether the Web pages have been changed. The database 2 connects with the application server 1, and is used for storing the information, including the historical information and the current information, of the Web pages browsed by the application server 1. The client 3 connects with the application server 1, and is used for providing an operation interface to users. A firewall 4 is generally set between the application server 1 and the Web server 6 for managing the Internet security.

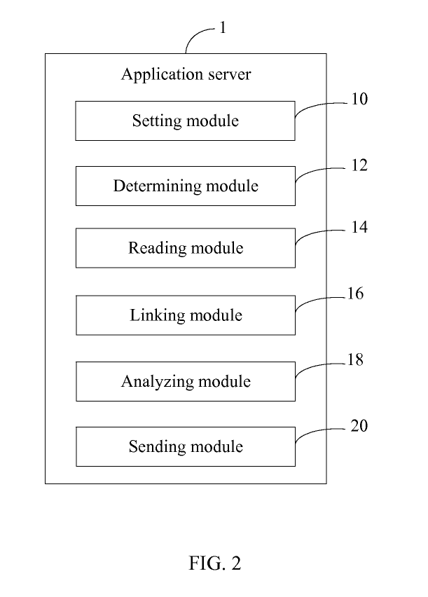

FIG. 2 is a schematic diagram of the main function units of the application server 1. The application server 1 typically includes a setting module 10, a determining module 12, a reading module 14, a linking module 16, an analyzing module 18, and a sending module 20.

The setting module 10 is configured for setting system working time. The system working time is the time for the system to detect target Web pages, such as 17:30-22:30 each day. When the current time is 17:30, the system begins to detect target Web pages.

The determining module 12 is configured for determining whether current time is within the system working time. For example, when the current time is 13:30, which is not within the system working time, the system does not detect any Web page.

The reading module 14 is configured for reading an XQuery document from the application server 1 if the determining module 112 determines that the current time is within the system working time. The XQuery is an XML Query Language, and is designed to be a language in which queries are concise and easily understood. Before the system runs, a URL of each target Web page and element selection options have been written into the XQuery document. For example, the element selection options may be:

<option id=“2003”>
<search xpath=“body/div/table[@class=“content”]/**” ></search>
<audit> <keyword> electron </keyword> </audit >
</option> .

The linking module 16 is configured for obtaining a Uniform Resource Locator (URL) of a Web page in the XQuery document and linking to the URL.

The determining module 12 is also configured for determining whether the Web page corresponding to the URL can be accessed.

The analyzing module 18 is configured for analyzing contents of the Web page to identify target contents by invoking the XQuery document if the Web page corresponding to the URL can be accessed. The Web page may be converted from the Hypertext Marked Language (HTML) format to the Extensible Markup Language (XML) format before being analyzed. The analyzing module 18 analyzes the XML Web page according to the element selection options of the XQuery document to identify target contents. For example, if the element selection option is:

<option id=“2003”>
<search xpath=“body/div/table[@class=“content”]/**” ></search>
<audit> <keyword> electron </keyword> </audit >
</option>

if the XML Web page contains:

<body> <div id=“article”>
<table class=“content”>electron </table>
< table >advantages </ table >
</div> </body>
the target contents would be:
<table class=“content”> electron </table>.

The determining module 12 is further configured for monitoring whether the target contents of the Web page have been changed by comparing the target contents of the Web page and the corresponding historical information of the Web page stored in the database 2. If the target contents of the Web page are identical with the historical information of the Web page, the determining module 12 judges that the target contents have not been changed; and if the target contents of the Web page are not identical with the historical information of the Web page, the determining module 12 judges that the target contents have been changed.

The sending module 20 is configured for sending a message of alterations to the URL to related operators if the Web page corresponding to the URL can not be accessed. The sending module 20 is also configured for sending a message of alterations to the target contents to related operators if the target contents of the Web page have been changed.

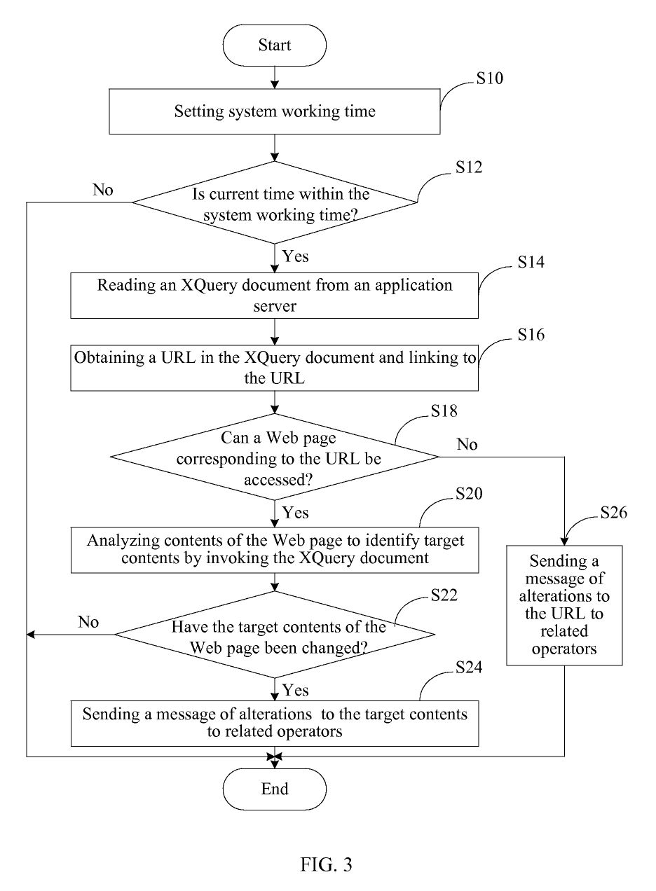

FIG. 3 is a flowchart of a preferred method for monitoring Web page alterations in accordance with a preferred embodiment. In step S10, the setting module 10 sets system working time.

In step 12, the determining module 12 determines whether current time is within the system working time.

If the current time is within the system working time, in step S14, the reading module 14 reads an XQuery document from the application server 1.

Otherwise, if the current time is not within the system working time, the procedure ends.

In step S16, the linking module 16 obtains a URL of a Web page in the XQuery document and links to the URL.

In step S18, the determining module 12 determines whether the Web page corresponding to the URL can be accessed.

If the Web page corresponding to the URL can be accessed, in step S20, the analyzing module 18 analyzes contents of the Web page to identify target contents by invoking the XQuery document.

Otherwise, if the Web page corresponding to the URL can not be accessed, in step S26, the sending module 20 sends a message of alterations to the URL to related operators if the Web page corresponding to the URL can not be accessed.

In step S22, the determining module 12 monitors whether the target contents of the Web page have been changed.

If the target contents of the Web page have been changed, in step S24, the sending module 20 sends a message of alterations to the target contents to related operators.

Otherwise, if the target contents of the Web page have not been changed, the procedure ends.

Although the present invention has been specifically described on the basis of a preferred embodiment and a preferred method, the invention is not to be construed as being limited thereto. Various converts or modifications may be made to said embodiment and method without departing from the scope and spirit of the invention.

What is claimed is:

1. A system for monitoring Web page alterations comprising an application server, a database coupled to the application server, and a Web server electronically connected with the application server via a network, the application server comprising:
a setting module for setting system working time;
a determining module for determining whether current time is within the system working time;
a reading module for reading an XQuery document from the application server if the current time is within the system working time;
a linking module for obtaining a Uniform Resource Locator in the XQuery document and linking to the Uniform Resource Locator; and
an analyzing module for analyzing contents of a Web page corresponding to the Uniform Resource Locator to identify target contents by invoking the XQuery document if the Web page corresponding to the Uniform Resource Locator can be accessed, wherein the determining module is configured for monitoring whether the target contents of the Web page have been changed.

2. The system as claimed in claim 1, wherein the application server further comprises:
a sending module for sending a message of alterations to the Uniform Resource Locator to related operators if the Web page corresponding to the Uniform Resource Locator can not be accessed, and for sending a message of alterations to the target contents to related operators if the target contents of the Web page have been changed.

3. A computer-based method for monitoring Web page alterations, the method comprising:
setting system working time;
determining whether current time is within the system working time;
reading an XQuery document from an application server if the current time is within the system working time;
obtaining a Uniform Resource Locator in the XQuery document and linking to the Uniform Resource Locator;
determining whether a Web page corresponding to the Uniform Resource Locator can be accessed;
analyzing contents of the Web page to identify target contents by invoking the XQuery document if the Web page corresponding to the Uniform Resource Locator can be accessed; and
monitoring whether the target contents of the Web page have been changed.

4. The method as claimed in claim 3, further comprising:
sending a message of alterations to the Uniform Resource Locator to related operators if the Web page corresponding to the Uniform Resource Locator can not be accessed.

5. The method as claimed in claim 3, further comprising:
sending a message of alterations to the target contents to related operators if the target contents of the Web page have been changed.
